(19) United States
(12) Patent Application Publication
(10) Pub. No.: US 2005/0132634 A1
(43) Pub. Date: Jun. 23, 2005

(54) Jig head with independent weight

(76) Inventor: Herbert Reed, Southington, CT (US)

Correspondence Address: Timothy A. Johnson;McCormick, Paulding & Huber, LLP, City Place II, 185 Asylum Street, Hartford, CT, 06103, US

(21) Appl. No.: 10/746,600

(22) Filed: Dec. 23, 2003

(51) Int. Cl. A01K 83/06

(52) U.S. Cl. 43/44.81

(57) ABSTRACT

The invention is a jig head wherein a weight is attached to an appendage extending from the shank portion of the jig head. The appendage can be either fixedly or slidably attached to the shank and the weight can be permanently or temporarily attached to the appendage. Depending upon the configuration, the design offers the ability to change or relocate the weight relative to the shank thereby changing the operational characteristics of the jig head without having to remove the jig head from a fishing line. In addition, decoration of the weight can be done independently of the manufacture of the jig head thereby reducing manufacturing cost.

### FIELD OF THE INVENTION

The present invention relates generally to fishing lures and more specifically relates to a jig head for use with such lures.

### BACKGROUND OF THE INVENTION

Fishing lures come in numerous styles of which the jig head is one. A jig head is characterized by a fishhook having a weight attached thereto. In use, live bait such as a minnow or other lures, can be attached to the fishhook portion of the jig head. The jig head is then placed in the water either by dropping or casting.

In general, the weight portion of a jig head is integrated with the fishhook. More specifically, the weight is secured around the shank portion of the fishhook in the area of the eye of the fishhook. In use, a fishing line is generally attached to the jig head through the eye. The fixed configuration of the fishhook and the weight result in numerous use and production issues.

In use, the fixed configuration of the jig head means that the characteristics of the jig head, such as the influence of the center of gravity on the jig head's movement through the water, cannot be changed. As a result, if the fisherman desires a jig head with different characteristics, the fisherman must remove the jig head from the fishing line and attach another thereto, or add more weight to the fishing line.

In manufacture, jig heads present several challenges. First the weight is designed such that the weight can be molded about the shaft of the hook. This tends to limit the shape and the overall mass of the weight. In addition, many jig heads have the weight portion of the jig head decorated. Decorations applied to the weight prior to the installation of the weight on the hook must be able to withstand the weight installation procedure and potentially the high temperature process of tempering of the hook. If the weight is decorated after installation on the hook, the hook portion must be protected to avoid inadvertent decoration of the hook. Either of the above issues tends to increase the cost of manufacturing the jig head. Finally, integration of other features such as weed guards into the jig head are 5 complicated.

Another problem with present day jig heads is the relationship between the weight and the fishhook. In current designs, the size of the weight is generally a function of the size of the hook. If the weight is made too large, the weight will interfere with the operation of the hook. More specifically, the weight can partially block the hook end of the fishhook thus compromising the ability of the fisherman to set the hook in the mouth of the fish.

Based on the foregoing, it is the object of the present invention to develop a jig head that overcomes the problems and drawbacks associated with the prior art.

### SUMMARY OF THE INVENTION

The present invention is a jig head that includes a fishhook having a shank and hook portion extending therefrom and an eye. An appendage extends from the shank between the eye and the hook portion. A weight is attached to the appendage in fixed position relative thereto.

While the appendage can be forged or cast with the fishing hook, it is preferred that the appendage be coupled to the shank of the fishing hook after manufacture thereof. Coupling of the appendage to the shank can be accomplished by a sleeve that has the appendage extending therefrom. The sleeve can be of almost any material, and the appendage can be rigid or flexible. In some applications, the sleeve and appendage will be a single assembly. The sleeve and appendage can be made of the same material or different materials. In addition, the appendage can be deformable permitting the appendage to be bent into numerous different positions. Possible materials for the sleeve and appendage are latex, plastisol, or silicon rubber. The sleeve can either be fixedly positioned on the shank, or be moveably positionable on the shank. In the event the sleeve is moveably positionable on the shank, there should be means, such as friction or stop(s), to hold the sleeve in place on the shank during use. The appendage can extend from the shank in any direction, such as toward the hook portion, toward the eye, or perpendicular. It is generally preferred, that the appendage extend from the shank such that the weight when attached thereto does not interfere with the hook portion of the fishing hook.

When a sleeve is employed to secure the appendage to the shank of the fishhook, the sleeve can have a flare. The flare is generally positioned on the end of the sleeve closest to the hook portion; however, it can be placed anywhere on the sleeve.

The weight can be of almost any shape. For example, the weight can be a regular solid shape such as sphere, rectangular solid, or fustrum, or irregular solids. In some cases, the weight can have a bore passing therethrough, such that a fishing line can be passed through the weight before being tied about the eye. The bore can be associated with a slot extending to a surface of the weight thereby permitting a fishing line to be attached to the eye first and then positioned within the bore or removed from the bore without having to disconnect the fishing line from the eye.

The weight is coupled to the appendage either permanently or temporarily. If a temporary attachment is desired, threads or various types of snap mechanisms could be used.

### BRIEF DESCRIPTION OF THE DRAWINGS

FIG. 1 is a side elevational view of the present invention.

FIG. 2 is a side elevational view of a second embodiment of the present invention.

FIG. 3 is a side elevational view of a third embodiment of the present invention.

FIG. 4 is a side elevational view of a fourth embodiment of the present invention.

FIG. 5 is a side elevational view of a fifth embodiment of the present invention.

FIG. 6 is a side elevational view of the jig head of FIG. 1 used in a first spinner arrangement.

FIG. 7 is a side elevational view of a jig head similar to that of FIG. 1 used in a second spinner arrangement.

FIG. 8 is a side elevational view of a jig head similar to that of FIG. 1 used in a third spinner arrangement.

FIG. 9 is a side elevational view of the jig head depicted in FIG. 1 with 20 wires to prevent catching of the hook on obstacles.

### DETAILED DESCRIPTION

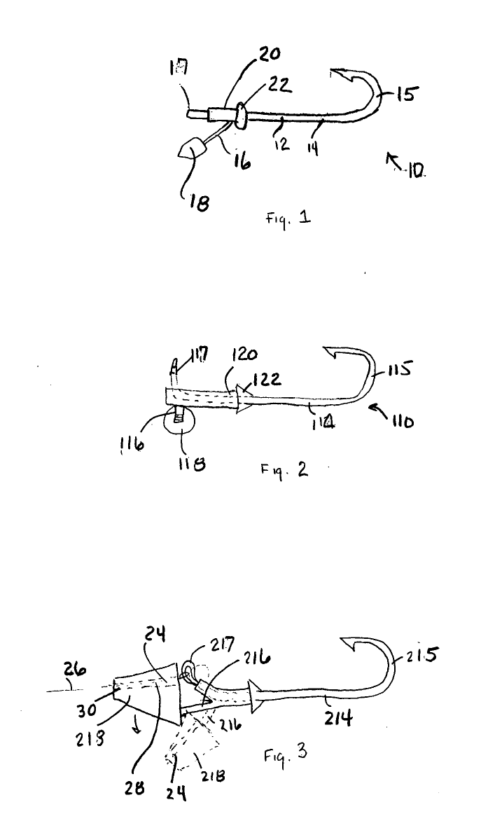

As shown in FIG. 1, the present invention, generally denoted by the reference number 10, includes a fishhook 12 having a shank 14 and a hook portion 15 extending laterally therefrom. The shank 14 also has an eye 17 from which the shank 14 extends. An appendage 16 extends from the shank 14 intermediate of the eye 17 and the hook portion 15. A weight 18 is attached to the distal end of appendage 16. As shown in the illustrated embodiment and with regard to any other embodiment described herein, the weight 18 is attached to the appendage 16 in a fixed relationship relative thereto.

As shown in FIG. 1, in this embodiment, the appendage 16 extends from the shank 14 by use of a sleeve 20, which surrounds the shank 14. In the illustrated embodiment, a flare 22 is provided on the edge of the sleeve 20 closest to the hook portion 15. The flare 30, however, can be positioned anywhere on the sleeve 20. The appendage 16 extends away from the hook portion 15 in the direction of the eye 17. This, however, is not a requirement of the jig head 10 as the appendage 16 could be perpendicular to the shank 14 or even extend away from the eye 17 in the direction of the hook portion 15. In addition, multiple appendages with each having a weight, or weights, could be used.

The appendage 16 can be rigid or flexible and can also be bendable, permitting the appendage 16 to be relocated from a first position to a second position. The ability to bend the appendage 16 permits easy relocation of the weight relative to the fishhook 12 offering the fisherman the option of changing the characteristics of the jig head 10, in this case by relocating the center of gravity, without removing the jig head 10 from a fishing line (not shown).

The weight 18 is attached to the appendage 16 either permanently or temporarily. In addition, the sleeve 20 can be fixedly attached or moveably attached to the shank 14. Where the weight 18 is temporarily attached to the appendage 16, the characteristics of the jig head 10 can be changed by changing the weight 18, thus avoiding removal of the jig head 10 from a fishing line.

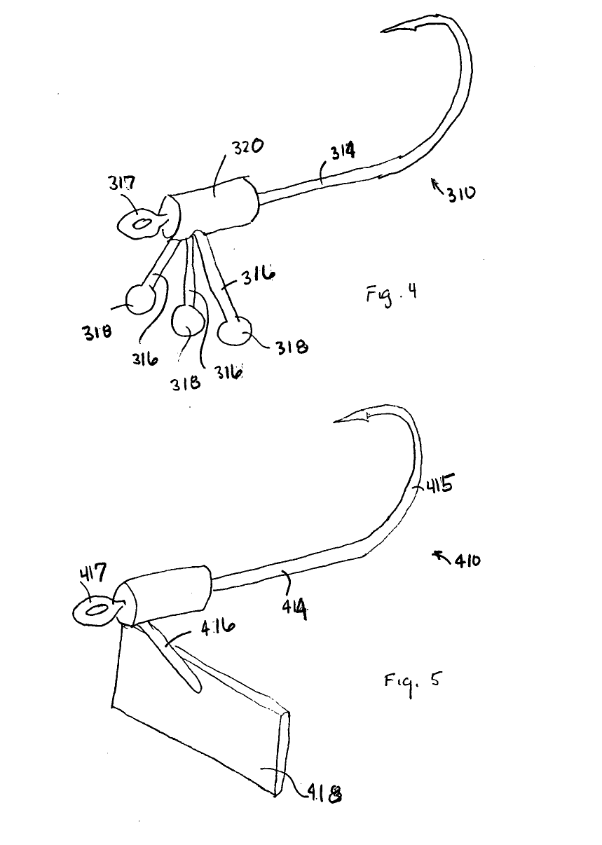

A second embodiment of a jig head 110 is shown in FIG. 2. The jig head 110 is similar in may respects to the jig head 10 described above and therefore like reference numerals preceded by the number 1 are used to indicated like elements. As shown in FIG. 2, the weight 118 is threadably attached to the appendage 116. As those skilled in the art of attachment will realize many different temporary attachment schemes could be used including but not limited to friction, and ball and socket. In addition, either the weight 118 and/or the appendage 116 could provide the attachment. For example in the case of threads, male threads could be on the appendage with matching female threads in the weight, or the female threads in the weight could cut threads into the appendage or visa versa.

As with the embodiment depicted in FIG. 1, this embodiment employs the sleeve 120 and the flare 122. The sleeve 120 can either be fixedly or moveably attached to the shank 114 intermediate of the eye 117 and the hook portion 115.

A third embodiment is shown in FIG. 3. The jig head 210 is similar in may respects to the jig heads 10 and 110 described above and therefore like reference numerals preceded by the number 2 are used to indicate like elements. In this embodiment, the appendage 216 extends from the shank 214 such that the weight 218 is positioned away from the hook portion 215 and behind the eye 217. A bore 24 extends through the weight 218, thereby permitting a fishing line 26 to pass therethrough. This embodiment also shows a deformable appendage 216. The appendage 216 is shown in phantom bent from a first position to a second position. In the second position, it is no longer desirable to pass the fishing line 26 through the bore 24. The bore 24 can have a slot 28 extending from the bore 24 to an outer surface 30 of the weigh 218 such that the fishing line 26 can be positioned in or removed from the bore 24 without having to disconnect the fishing line 26 from the eye 217.

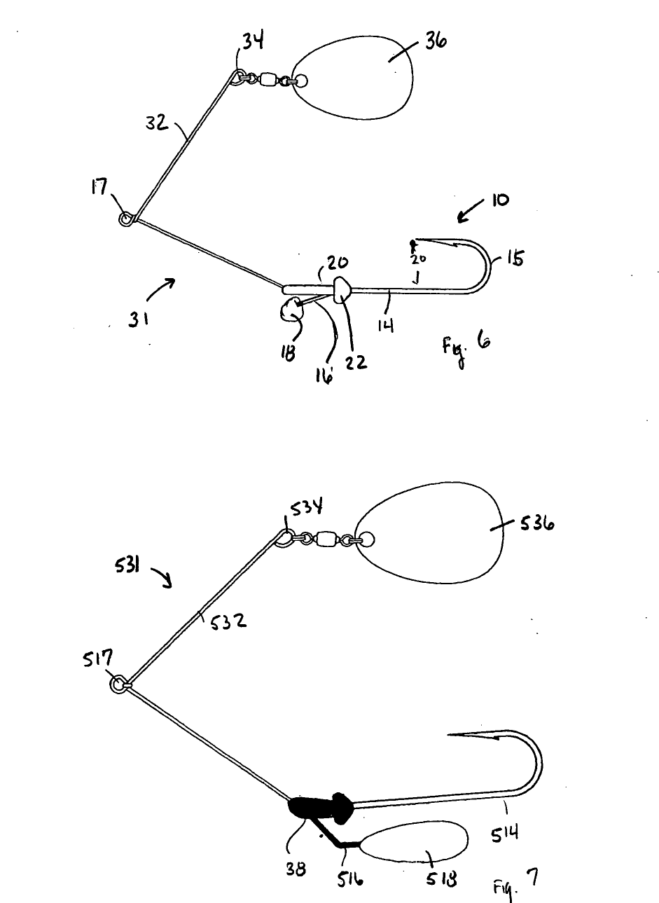

FIG. 4 is yet another embodiment of the present invention. The jig head 310 is similar in may respects to the jig heads 10, 110 and 210 described above and therefore like reference numerals preceded by the number 3 are used to indicated like elements. This embodiment depicts multiple appendages 316 extending from the shank 314, each appendage 316 extending from the common sleeve 320. The invention, however, should not be limited to a single sleeve for multiple appendage configurations, as multiple sleeves could be used. In this embodiment, a weight 318 is attached to each appendage 316. This, however, is not required in that all appendages 316 do not have to have weights attached thereto.

FIG. 5 depicts a fifth embodiment of the basic invention as shown in FIG. 1. The jig head 410 is similar in may respects to the jig heads 10, 110, 210 and 310 described above and therefore like reference numerals preceded by the number 4 are used to indicated like elements. In this embodiment, the weight 418 is a rectangular solid. The weight 418 could be of any shape thereby providing numerous actions to the jig head. Any particular shape is application dependent. In addition, the appendage 416 extends from the shank 414 in a direction away from the eye 417 toward the hook portion 415.

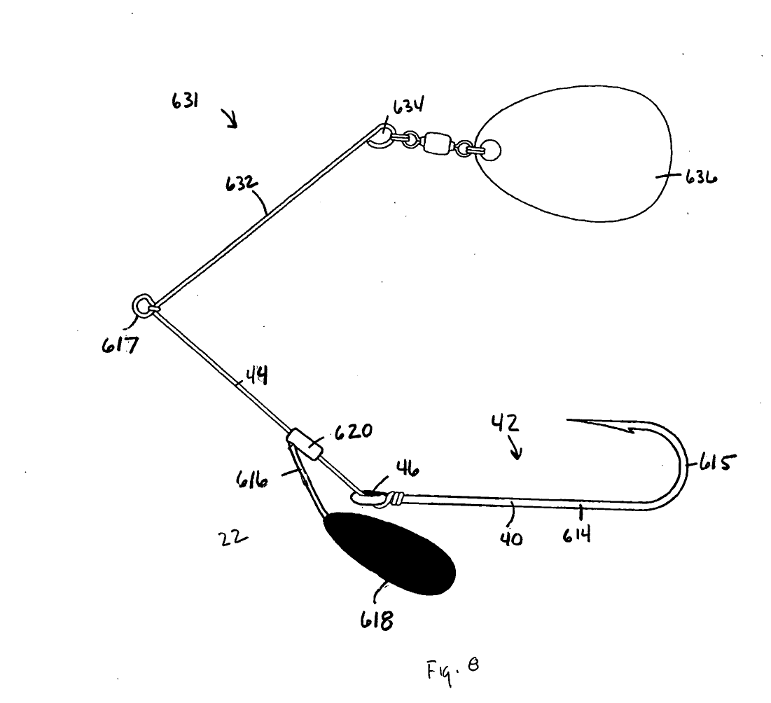

FIG. 6 depicts the jig head 10 depicted in FIG. 1 used in a spinnerbait, generally referred to by reference numeral 31. As the jig head portion of the spinnerbait 31 is the jig head depicted in FIG. 1, the numbering of the elements of the jig head portion of the spinnerbait are consistent with the numbering used in FIG. 1. In the spinnerbait 31, the shank 14 is bent between the hook portion 15 and the eye 17. In this spinnerbait 31 as with spinnerbaits in general, a second appendage 32 extends from the shank 14 in the vicinity of the eye 17. Attached to a distal end 34 of the second appendage 32 is a spinner 36. The spinner 36 is attached to the distal end 34 in such a way as to permit the spinner 36 to move relative to the second appendage 32.

FIG. 7 is a second embodiment of a spinnerbait, generally referred to by reference number 531, that is similar in many respects to spinnerbait 31 depicted in FIG. 6, therefore like reference numerals preceded by the numeral 5 are used to indicate like elements. In this embodiment, the shank 514 has a flexible section 38 from which the appendage 516 extends. It should be understood that the invention is not so limited as the appendage 516 could extend from the shank 514 and the shank 514 could have an flexible section 38 that did not have an appendage extending therefrom. The weight 518 is coupled to the appendage 516. Consistent with other spinnerbaits, the spinnerbait 531 has the second appendage 532 extending from the shank 514 in the vicinity of the eye 517. Attached to the distal end 534 of the second appendage 532 is the spinner 536 which is attached in such a way as to permit movement of the spinner 536 relative to the second appendage 532.

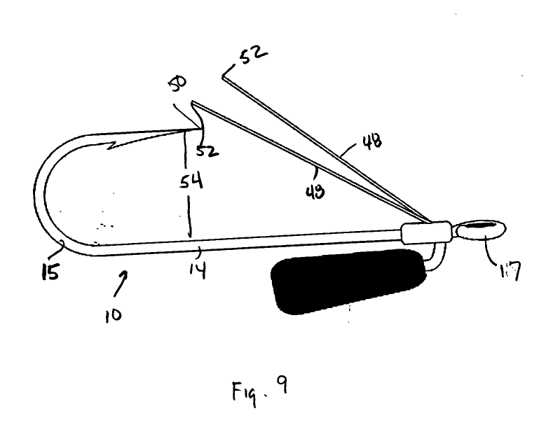

FIG. 8 is a third embodiment of a spinnerbait, generally referred to by reference number 631, that is similar in many respects to the spinnerbaits 31 and 531 depicted in FIGS. 6 and 7, respectively, therefore like reference numerals preceded by the numeral 6 are used to indicate like elements. In this embodiment, the shank 614, which extends from the eye 617 to the hook portion 615, is comprised of a conventional shank portion 40 of a standard fishhook 42 and an extension 44 which is secured through an eye 46 of the standard fishhook 42. In this embodiment, the appendage 616 is connected by the sleeve 620 to the extension 44; however, it could have been connected to shank portion 40. The sleeve 620 is designed to slide on the extension 44. Consistent with other spinnerbaits, the spinnerbait 631 has the second appendage 632 extending from the shank 614 in the vicinity of the eye 617. Attached to the distal end 634 of the second appendage 632 is the spinner 636 which is attached in such a way as to permit movement of the spinner 636 relative to the second appendage 632.

Finally, FIG. 9 depicts the jig head 10 of FIG. 1 with wires 48 extending from the shank 14 in the vicinity of the eye 17 toward the hook portion 15 in the vicinity of a point 50. Each wire has a free end 52 that projects over a gap 54. As those skilled in the design of fishing lures will appreciate, the wires 48 have sufficient strength such that when the jig head 10 encounters obstacles such as weeds or logs the obstacle rides along the wires 48 and the wires do not flex or bend to expose the point 50. As a result, the hook portion 15 does not snag the obstacle. However, when a fish bits the hook portion 15, the jaws of the fish flexes the wires 48 such that the point 50 is exposed permitting a portion of the hook portion 15 to be embedded in the fish.

Although the present invention has been described in considerable detail with reference to certain preferred version thereof, other versions are possible. Therefore, the spirit and scope of the invention should not be limited to the description of the preferred versions contained herein.

1. A jig head comprising:
a fishhook having a shank, a hook portion extending from one end of the shank, and an eye extending from another end of the shank generally opposite the hook portion;
a sleeve disposed on the shank;
an appendage coupled to the sleeve; and
a weight connected to the appendage in a fixed relationship relative thereto.

2. (canceled)

3. The jig head of claim 1 wherein the weight is releasably coupled to the appendage.

4. The jig head of claim 3 wherein the weight threadably engages the appendage.

5. The jig head of claim 3 wherein the weight snappingly engages the appendage.

6. The jig head of claim 1 wherein the sleeve is in fixed position on the shank.

7. The jig head of claim 1 wherein the sleeve is flared between the appendage and the hook portion.

8. The jig head of claim 1 further comprising another appendage coupled to the sleeve and extending therefrom.

9. The jig head of claim 1 wherein the weight defines a bore for passing a fishing line therethrough.

10. The jig head of claim 9 further comprising a slot extending from the bore to a surface of the weight permitting the positioning of a line within the bore by passing the line through the slot.

11. The jig head of claim 9 wherein the weight is frusto conically shaped.

12. The jig head of claim 1 wherein there are a plurality of appendages with at least one appendage having a weight attached thereto.

13. (canceled)

14. The jig head of claim 1 wherein the appendage is flexible.

15. The jig head of claim 1 wherein the appendage is rigid.

16. The jig head of claim 1 further including at least one wire attached to the shank proximate to the eye and having an end proximate to a point of the hook section.

17. The jig head of claim 16 wherein there are at least two wires, the ends thereof divided by the point.

18. The jig head of claim 1 wherein the sleeve is freely slidably disposed on the shank.
